(19) United States
(12) Patent Application Publication
(10) Pub. No.: US 2006/0097891 A1
(43) Pub. Date: May 11, 2006

(54) Apparatus for sensing tire information, reducing distortion of amplitude-modulated wave

(75) Inventor: Kota Iijima, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/282,635

(22) Filed: Nov. 3, 2005

(30) Foreign Application Priority Data
Nov. 9, 2004 (JP) 2004-325467

(51) Int. Cl. G08C 19/00

(52) U.S. Cl. 340/825.72; 152/415; 340/445

(57) ABSTRACT

An apparatus for sensing tire information including information about tire pressure includes an interrogator for transmitting an interrogation signal to a vicinity of a tire of a vehicle in a transmission period and for receiving and processing a response signal including the tire information in a reception period and a transponder attached to the tire. The transponder includes a sensor sensing the tire information and a second mixing unit for mixing first and second signals and outputting a difference signal having a frequency equal to a difference in frequency between the first and second signals. In the transmission period, a second antenna is connected to a second oscillator by a first switching unit, and the first and second signals are transmitted from a first antenna and the second antenna of the interrogator. The first signal is different from the second signal by a predetermined frequency that can excite the sensor.

### BACKGROUND OF THE INVENTION

1. Field of the Invention

The present invention relates to an apparatus for sensing tire information to monitor tire pressure or the like.

2. Description of the Related Art

A conventional apparatus for sensing tire information is described with reference to FIG. 4. A controller contains at least one radio-frequency generator G1 for a carrier signal f1, preferably in the microwave frequency band around 2.4 GHz, which is modulated by at least one lower-frequency signal f2, produced by a generator G2, preferably in the frequency band from 1 to 30 MHz. This modulation results in the required supply frequencies being produced. The resultant signal is amplified and is emitted via an antenna A1 in the vicinity of a tire.

The modulation is preferably amplitude modulation. According to such modulation forms, further sidebands are produced in the spectrum to the left and right alongside the carrier frequency, specifically, for example, at f1+f2 and f1−f2 for amplitude modulation. If a plurality of frequencies f2 are used, their sum results in a sideband spectrum which is illustrated, using an example, in the drawing. The modulation can be switched off by an electronic switch S1, and the switch is controlled cyclically by a timer T1.

The tire contains at least one measured value transmitter MG1 (transponder), including at least one antenna A2, a receiver with at least one diode D1, and a crystal resonator Q1 which is excited by the received modulation signal. The crystal resonator Q1 changes its resonant frequency under the influence of tire pressure and is now itself once again coupled to a modulator diode or mixer diode D2, preferably a varactor diode allowing parametric gain. Furthermore, its frequency is varied by the measured value. The modulation is now switched off by the switch S1 at a time t1, and a receiver E1 is activated shortly after this at a time t2, with t2 following about 1 μs after t1.

If the modulation of the supply frequency is now switched off, then the crystal resonator Q1 still continues to oscillate for about 1 ms and, since the carrier is still present, this supply frequency is modulated via the modulator diode D2. However, this occurs only once the modulation frequency f2 has already excited the crystal Q1, that is to say, when the modulation frequency corresponds roughly to the possible measured value. The receiver now sees a modulated signal of an antenna A3 at its antenna A4 without the supply signal being modulated by the antenna A1, which could cause interference, and can thus deduce the measured value from the modulation. In the absence of modulation or if the modulation is too weak, further possible measured values can be sampled iteratively (see, for example, Japanese Patent No. 3,494,440, in particular, FIG. 5).

In the transponder MG1, an amplitude-modulated wave is detected by the diode D1, a modulation wave of the lower-frequency signal f2 is detected, and the detected modulation wave excites the crystal resonator Q1. To sufficiently excite the crystal resonator Q1, a large modulation factor for the amplitude-modulated wave is necessary. However, if the modulation factor is made larger in order to facilitate exciting it, the modulation wave becomes largely distorted and spurious radiation occurs. If the modulation factor is reduced in order to avoid the spurious problem, the modulation level is lower and the crystal resonator cannot be sufficiently excited.

### SUMMARY OF THE INVENTION

It is an object of the present invention to avoid a problem resulting from distortion of amplitude-modulated waves output from a controller (interrogator).

An apparatus for sensing tire information including information about tire pressure according to an aspect of the present invention includes an interrogator for transmitting an interrogation signal to a vicinity of a tire of a vehicle in a transmission period and for receiving and processing a response signal including the tire information in a reception period, and a transponder attached to the tire, the transponder including a sensor capable of being excited by a signal having a predetermined frequency, the sensor being used for sensing the tire information, the transponder being for sending the response signal to the interrogator in response to the interrogation signal in the reception period. The interrogator includes a first oscillator for outputting a first signal, a second oscillator for outputting a second signal, the first signal and the second signal being used for constituting the interrogation signal, a frequency of the first signal being different from a frequency of the second signal by the predetermined frequency, a first antenna connected to the first oscillator, a second antenna for transmitting the second signal, and a switching unit for connecting the second antenna to one of the first antenna and the second oscillator. The transponder includes a second mixing unit for mixing the first signal and the second signal and outputting a difference signal having a frequency equal to a difference in frequency between the first signal and the second signal. In the transmission period, the second antenna is connected to the second oscillator by the switching unit, the first signal is transmitted from the first antenna, and the second signal is transmitted from the second antenna.

As described above, the interrogator includes the first oscillator for outputting the first signal, the second oscillator for outputting a second signal, the first signal and the second signal being used for constituting the interrogation signal, a frequency of the first signal being different from a frequency of the second signal by the predetermined frequency, the first antenna connected to the first oscillator, the second antenna for transmitting the second signal, and the switching unit for connecting the second antenna to one of the first antenna and the second oscillator. The transponder includes the second mixing unit for mixing the first signal and the second signal and outputting a difference signal having a frequency equal to a difference in frequency between the first signal and the second signal. In the transmission period, the second antenna is connected to the second oscillator by the switching unit, the first signal is transmitted from the first antenna, and the second signal is transmitted from the second antenna. Therefore, merely transmitting the first signal and the second signal from the interrogator enables the transponder to be excited, without transmitting amplitude-modulated waves from the interrogator. As a result, a problem resulting from distortion of amplitude-modulated waves is avoided.

The apparatus described above may further include a first mixing unit disposed between the first oscillator and the first antenna. In the transmission period, the first signal may be output to the first antenna via the first mixing unit, and, in the reception period, the second antenna may be connected to the first antenna by the switching unit, and the response signal received by the first antenna and the second antenna and the first signal may be input to the first mixing unit.

Therefore, the response signal from the transponder can be demodulated by being synchronously detected by the first mixing unit.

In the apparatus described above, the second antenna may be connected to the switching unit via a delay line, and a length of the delay line may be equal to a distance between the first antenna and the second antenna.

Therefore, the effect of fading is reduced.

### BRIEF DESCRIPTION OF THE DRAWINGS

FIG. 1 is a circuit diagram of an apparatus for sensing tire information according to an embodiment of the present invention;

FIG. 2 is a circuit diagram of an embodiment of a first mixing unit used in an apparatus for sensing tire information according to an embodiment of the present invention;

FIG. 3 shows a format of an interrogation signal in an apparatus for sensing tire information according to an embodiment of the present invention; and

FIG. 4 is a circuit diagram of a conventional apparatus for sensing tire information.

### DESCRIPTION OF THE PREFERRED EMBODIMENTS

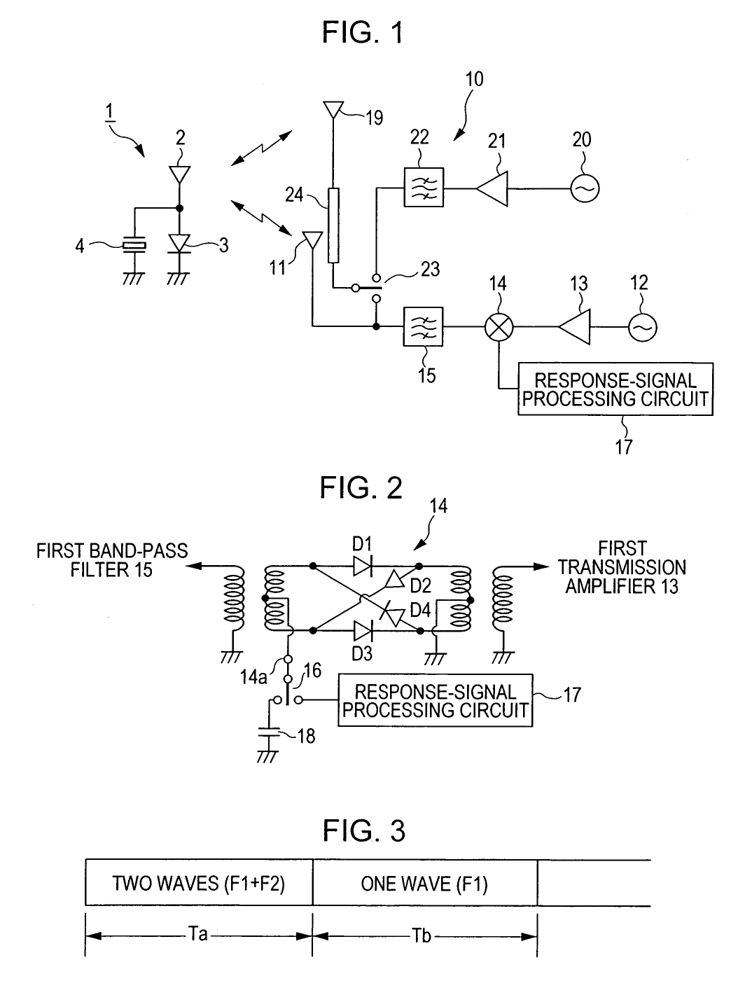

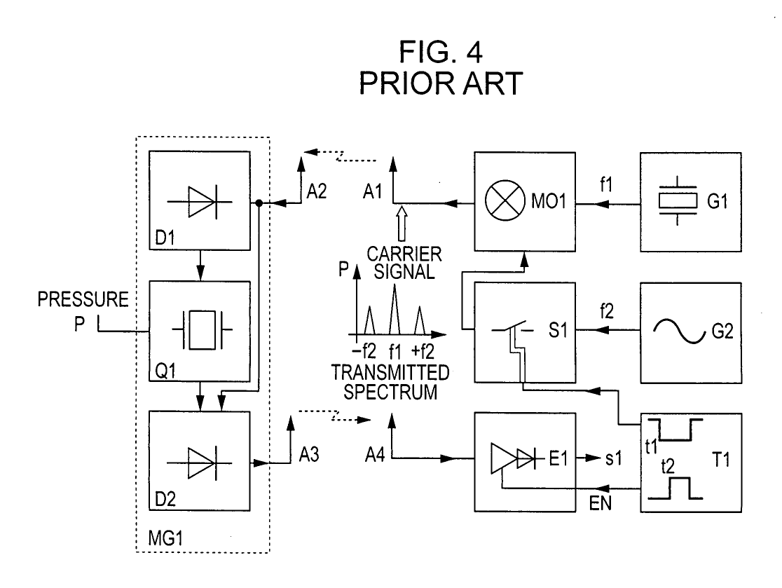

An embodiment of an apparatus for sensing tire information is described below with reference to FIGS. 1 to 3. In FIG. 1, a transponder 1 is attached to a tire (not shown) of a vehicle. A main body (not shown) of the vehicle is provided with an interrogator 10.

The transponder 1 includes an antenna 2, a second mixing unit 3 connected to the antenna 2, and a sensor 4 connected to the second mixing unit 3. The second mixing unit 3 is a non-linear device (e.g., a diode) and functions as both a frequency converting unit and a modulating unit. The sensor 4 includes a crystal resonator in which self resonance occurs when excited by a signal having a self-resonant frequency or a frequency close thereto (e.g., about 10 MHz). The resonant frequency varies with tire pressure, temperature, and the like. The number of sensors 4 corresponds to tire information to be sensed, i.e., a plurality of sensors 4 may be used.

The interrogator 10 includes a first antenna 11, a first oscillator 12 connected to the first antenna 11, a first transmission amplifier 13, a first mixing unit 14, and a first band-pass filter 15. The first transmission amplifier 13, the first mixing unit 14, and the first band-pass filter 15 are disposed between the first antenna 11 and the first oscillator 12. The first transmission amplifier 13 is disposed between the first oscillator 12 and the first mixing unit 14. The first band-pass filter 15 is disposed between the first antenna 11 and the first mixing unit 14. The first oscillator 12 generates a first signal (oscillation frequency F1=2.4 GHz).

As shown in FIG. 2, the first mixing unit 14 is, for example, a bidirectional double-balanced mixer including four diodes D1 to D4. A demodulation output terminal 14a of the first mixing unit 14 can be connected to a response-signal processing circuit 17 or a direct-current power supply 18 via a second switching unit 16.

The interrogator 10 further includes a second antenna 19 and a second oscillator 20. The second oscillator 20 generates a second signal (oscillation frequency F2=2.41 GHz). The difference in frequency between the first and second signals is 10 MHz, and the frequency of this difference signal is a frequency that can excite the sensor 4 in the transponder 1. The second oscillator 20 is connected to a second transmission amplifier 21 and a second band-pass filter 22 at its output side in the order illustrated in FIG. 1. The second antenna 19 can be connected to the first antenna 11 or the second band-pass filter 22 via a first switching unit 23. The second antenna 19 is connected to the first switching unit 23 via a delay line 24. The length of the delay line 24 is substantially equal to the distance between the first antenna 11 and the second antenna 19.

The operation of an apparatus for sensing tire information according to an embodiment of the present invention is described below. Typical examples of tire information include information about tire pressure and tire temperature. For convenience of explanation, tire-pressure sensing is described. If tire temperature is sensed, the transponder 1 would include another sensor for it.

As shown in FIG. 3, an interrogation signal to be transmitted to the transponder 1 is divided into a transmission period Ta and a reception period Tb. In the transmission period Ta, the first switching unit 23 connects the second antenna 19 to the second band-pass filter 22 (a side adjacent to the second oscillator 20), and the second switching unit 16 connects the demodulation output terminal 14a of the first mixing unit 14 to the direct-current power supply 18.

The application of power by the direct-current power supply 18 brings the diodes D1 and D3 in the first mixing unit 14 into conduction, and the first signal output from the first oscillator 12 is sent to the first band-pass filter 15 via the first mixing unit 14 and transmitted from the first antenna 11. The second signal output from the second oscillator 20 is transmitted from the second antenna 19 via the first switching unit 23. As a result, in the transmission period Ta, the first signal and the second signal (F1+F2) are received at the antenna 2 in the transponder 1.

In the transponder 1, the received signals (F1, F2) are mixed by the second mixing unit 3, a difference signal (10 MHz), which has a frequency equal to the difference in frequency between these signals, is generated, and the difference signal excites the sensor 4. Then, the sensor 4 resonates at its self-resonant frequency, and the resonance state continues. Since this resonant frequency varies with variations in tire pressure, the resonant frequency represents information about tire pressure.

When the operation moves to the next reception period Tb, the first switching unit 23 connects the second antenna 19 to the first antenna 11. Then, the first signal is transmitted from the first antenna 11 and the second antenna 19. The first signal is amplitude-modulated with the difference signal (10 MHz) by the second mixing unit 3 in the transponder 1. The amplitude-modulated (AM) wave is emitted from the antenna 2. The AM wave is received by the first antenna 11 and the second antenna 19 and input to the first mixing unit 14 via the first band-pass filter 15.

Shortly thereafter, the second switching unit 16 disconnects the first mixing unit 14 from the direct-current power supply 18, and the demodulation output terminal 14a is then connected to the response-signal processing circuit 17. Since the first signal from the first oscillator 12 is also input to the first mixing unit 14, the first mixing unit 14 operates as a synchronous detector (the frequency of the AM wave is the same as that of the first signal). A detection signal (10 MHz) obtained from the detection is output from the first mixing unit 14 and input to the response-signal processing circuit 17. The tire-pressure information processed by the response-signal processing circuit 17 is displayed on a display (not shown).

As described above, according to an embodiment of the present invention, the sensor 4 is excited by transmission of signals of two waves from the interrogator 10, without transmission of amplitude-modulated waves from the interrogator 10. Therefore, a spurious problem caused by distortion of the amplitude-modified waves is prevented. Additionally, since the response signal is received by the first antenna 11 and the second antenna 19 in the reception period, the antenna gain reception sensitivity is increased by 6 dB (power ratio).

Furthermore, since the delay line for the second antenna 19 is included, the effect of fading is reduced.

What is claimed is:

1. An apparatus for sensing tire information including information about tire pressure, the apparatus comprising:
an interrogator for transmitting an interrogation signal to a vicinity of a tire of a vehicle in a transmission period and for receiving and processing a response signal including the tire information in a reception period; and
a transponder attached to the tire, the transponder including a sensor capable of being excited by a signal having a predetermined frequency, the sensor being used for sensing the tire information, the transponder being for sending the response signal to the interrogator in response to the interrogation signal in the reception period,
wherein the interrogator includes:
a first oscillator for outputting a first signal;
a second oscillator for outputting a second signal, the first signal and the second signal being used for constituting the interrogation signal, a frequency of the first signal being different from a frequency of the second signal by the predetermined frequency;
a first antenna connected to the first oscillator;
a second antenna for transmitting the second signal; and
a switching unit for connecting the second antenna to one of the first antenna and the second oscillator,
wherein the transponder includes a second mixing unit for mixing the first signal and the second signal and outputting a difference signal having a frequency equal to a difference in frequency between the first signal and the second signal, and
wherein, in the transmission period, the second antenna is connected to the second oscillator by the switching unit, the first signal is transmitted from the first antenna, and the second signal is transmitted from the second antenna.

2. The apparatus for sensing tire information according to claim 1, further comprising a first mixing unit disposed between the first oscillator and the first antenna,
wherein, in the transmission period, the first signal is output to the first antenna via the first mixing unit, and
wherein, in the reception period, the second antenna is connected to the first antenna by the switching unit, and the response signal received by the first antenna and the second antenna and the first signal are input to the first mixing unit.

3. The apparatus for sensing tire information according to claim 2, wherein the second antenna is connected to the switching unit via a delay line, and a length of the delay line is equal to a distance between the first antenna and the second antenna.
